(19) United States
(12) Patent Application Publication
(10) Pub. No.: US 2025/0315909 A1
(43) Pub. Date: Oct. 9, 2025

(54) METHODS FOR AUTOMATING THE PROMPTING AND POST-PROCESSING OF AI SYSTEMS FOR INTERPRETATION AND REPORTING OF PUBLIC SAFETY DATA, STATISTICS, AND CONTEXTUAL KNOWLEDGE

(71) Applicant: Simsi, Inc., Cherry Hill, NJ (US)

(72) Inventors: Julius Parishy, Philadelphia, PA (US); Joel Caplan, Linwood, NJ (US)

(21) Appl. No.: 19/170,838

(22) Filed: Apr. 4, 2025

Related U.S. Application Data
(60) Provisional application No. 63/575,552, filed on Apr. 5, 2024.

(51) Int. Cl. G06Q 50/26

(52) U.S. Cl. CPC G06Q 50/265

(57) ABSTRACT

A method of textual report generation, comprising: receiving a proposed report description and a report intent; providing the proposed report description and the report intent to a first large language model; prompting the first large language model to output a quality rating of the proposed report description with respect to the report intent; prompting the user to revise the proposed report description until the quality rating exceeds a predetermined threshold; providing the proposed report description and the report intent to a second large language model; and prompting the second large language model to generate a report according to the proposed report description and the report intent.

### RELATED APPLICATION

This application claims the benefit of U.S. Provisional Application No. 63/575,552 filed Apr. 5, 2024, which is hereby incorporated by reference in its entirety.

### BACKGROUND

Public Safety Data is an integral input into the decision making of various government entities tasked with managing discrete aspects of the administration and regulation of public and private entities within their jurisdiction, ranging from law enforcement to public works to code/licensing enforcement, permitted businesses, and so on. Existing management structures of governments depend on civil employees with various levels of training and education to collect, store, manipulate, secure, and interpret Public Safety Data and disseminate it within their agency.

Technology products aimed at law enforcement and other productivity software aimed at other government agencies fail to acknowledge the cross-agency overlap of responsibility for Public Safety Programming and fail to deliver the ability for government entities to engage in interagency coordination and information sharing. They also fail to deliver the ability for government agencies to engage with non-governmental organizations (NGOs) for the purpose of Public Safety Programming.

As expectations of public agencies increase in response to public desire for safer communities that are policed using procedurally just methods as well as community involvement in decision making, novel tools are needed to bridge physical, operational, educational, and cultural gaps to enable the implementation of locally-driven Public Safety Programming.

### SUMMARY

In an example embodiment, the present disclosure is a method of textual report generation. The method comprises: receiving a proposed report description and a report intent; providing the proposed report description and the report intent to a first large language model; prompting the first large language model to output a quality rating of the proposed report description with respect to the report intent; prompting the user to revise the proposed report description until the quality rating exceeds a predetermined threshold; providing the proposed report description and the report intent to a second large language model; prompting the second large language model to generate a report according to the proposed report description and the report intent.

In some embodiments, the method comprises providing a user interface to a user and receiving from the user via the user interface the proposed report description and the report intent. In some embodiments, the method comprises outputting the report to the user.

In some embodiments, the quality rating corresponds to ambiguity.

In some embodiments, the method comprises, based on the proposed one or more of the report description and report intent, retrieving contextual data corresponding thereto, and providing the contextual data to the second large language model with the proposed report description and the report intent.

In some embodiments, a computer program product for textual report generation comprises a computer readable storage medium having program instructions embodied therewith. The program instructions can be executable by a processor to cause the processor to perform a method. The method can comprise receiving a proposed report description and a report intent. The method can comprise providing the proposed report description and the report intent to a first large language model. The method can comprise prompting the first large language model to output a quality rating of the proposed report description with respect to the report intent. The method can comprise prompting a user to revise the proposed report description until the quality rating exceeds a predetermined threshold. The method can comprise providing the proposed report description and the report intent to a second large language model. The method can comprise prompting the second large language model to generate a report according to the proposed report description and the report intent.

In some embodiments, the method executed by the processor further comprises providing a user interface to a user and receiving from the user via the user interface the proposed report description and the report intent. In some embodiments, the method executed by the processor further comprises outputting the report to the user.

In some embodiments, the quality rating corresponds to ambiguity.

In some embodiments, the method executed by the processor further comprises, based on the proposed one or more of the report description and report intent, retrieving contextual data corresponding thereto, and providing the contextual data to the second large language model with the proposed report description and the report intent.

In some embodiments, a system comprises a computing node comprising a computer readable storage medium having program instructions embodied therewith. The program instructions can be executable by a processor of the computing node to cause the processor to perform a method comprising receiving a proposed report description and a report intent. The method can comprise providing the proposed report description and the report intent to a first large language model. The method can comprise prompting the first large language model to output a quality rating of the proposed report description with respect to the report intent. The method can comprise prompting a user to revise the proposed report description until the quality rating exceeds a predetermined threshold. The method can comprise providing the proposed report description and the report intent to a second large language model. The method can comprise prompting the second large language model to generate a report according to the proposed report description and the report intent.

In some embodiments, the method executed by the processor can further comprise providing a user interface to a user and receiving from the user via the user interface the proposed report description and the report intent. In some embodiments, the method executed by the processor further comprises outputting the report to the user.

In some embodiments, the quality rating corresponds to ambiguity.

In some embodiments, the method executed by the processor further comprises, based on the proposed one or more of the report description and report intent, retrieving contextual data corresponding thereto, and providing the contextual data to the second large language model with the proposed report description and the report intent.

In another example embodiment, the present disclosure is a computer program product for textual report generation. The computer program product comprises a computer readable storage medium having program instructions embodied therewith, the program instructions executable by a processor to cause the processor to perform a method according to any one of the embodiments described herein.

### BRIEF DESCRIPTION OF THE DRAWINGS

The foregoing will be apparent from the following more particular description of example embodiments of the disclosure, as illustrated in the accompanying drawings in which like reference characters refer to the same parts throughout the different views. The drawings are not necessarily to scale, emphasis instead being placed upon illustrating embodiments of the present disclosure.

FIG. 1A and FIG. 1B, in combination, are schematic diagrams of an embodiment of the method and the system described according to embodiments of the present disclosure.

FIG. 2 is a schematic diagram of an embodiment of Contextual Completeness Check described according to embodiments of the present disclosure.

FIG. 3 is a schematic diagram of exemplary organizations of Risk Narrative Generation module, Report Content Generation module I, and Report Content Generation module II described according to embodiments of the present disclosure.

FIG. 4 is a schematic diagram of a computer node that can be employed by exemplary embodiments of the present disclosure.

### DETAILED DESCRIPTION DISCLOSURE

A description of example embodiments of the disclosure follows.

### Glossary

Certain terms used herein are defined below.

“Data”—As an example and not an exhaustive list, Data includes quantitative and qualitative representations of facts, knowledge, intuitions, work product, or any other source of information gathered for the purposes of decision making or visualization.

“Crime Data”-Data related to crime and associated activities.

“Public Health Data”-Data related to public health outcomes and other associated focuses.

“Public Safety Data”-Any Data sourced for the purposes of affecting Public Safety Programming and related decision making. It typically encompasses Crime Data and Public Health Data, but may include data from any Stakeholder involved in the Programming.

Public Safety Programming: Coordinated efforts which are intended to have an effect on crime, quality of life, health outcomes, and other priorities measured using Public Safety Data

“Source Information”-Data in its most usable original form. This is most often high level statistics originating from aggregating the original incident-level Data.

“Stakeholder”-Any person or group involved in Public Safety Programming.

“End User”-A Stakeholder who is responsible for generating reports using the Disclosure disclosed herein.

“Contextual Knowledge”-Data auxiliary to Source Information which is used to aid Public Safety Programming by providing answers to tangential Data questions, explaining historical actions, and other means for making better decisions using local Data from the past.

“Risk Narrative”-A written description of the relationship between an outcome and the places where the outcome tends to occur most often, intended to contextualize problems for Public Safety Programming.

“Narrative Reporting Service”—An exemplary embodiment of the disclosure disclosed herein.

“Report”—The presentation of Data, Contextual Knowledge, and other information in a specific format or frame of reference intended to clearly convey an operationally important message to various Stakeholders.

“Target Audience”—The intended recipient of a Report.

### Abbreviations

The following abbreviations are used herein.
“Server APP” means Server Application.
“RTM” means Risk Terrain Modeling.
“DB” means Database.
“NRS” means Narrative Reporting Service.
“CII” means Contextual Information Inserts.
“LLM” means Large Language Model.
“Op” means Operation.

### Narrative Reporting Service (“The NRS”)

In example embodiments, the present disclosure is an NRS as a software application which allows End Users to generate Reports through novel means of combining, processing, and transforming text and other data. The NRS is a stateful mechanism for applying a series of steps and transformations of input information into an output Report. The steps are described below. End Users interact with the NRS using a Web Browser to access the NRS Frontend and Application Programming Interfaces communicate between the Frontend and the NRS on the server where the application is hosted.

### Frontend Web Application

In example embodiments, the End User accesses the NRS frontend web application (“Frontend”) in order to interface with the disclosure (e.g., the NRS). The Frontend enables the End User to create new Analysis Report Context, which contains metadata about the Analysis Report and is stored in the Application Database. The Context allows the NRS to maintain state over various asynchronous tasks which include multiple phases of user feedback and iterative content generation. The Context also stores the report output for viewing and download once completed.

### Contextual Information Inserts

The Frontend allows the user to enter text-based information in a number of Contextual Information Inserts (“CII”). A CII is a piece of data that is identified by an Intent-Key-Value tuple that represent information the user wishes to be included as context for the generated outputs. The CII allows transformations of data through metadata that describes the intent of the Key Value (KV) pair.

For example, such an intent could be of the type “Detailed Description”, in which the Key is a word or phrase or concept and the Value is a detailed description of that Key. The NRS will include in its prompt that when Key is referenced, the Detailed Description in Value should be understood as its meaning. This is particularly useful in transforming information from a generic label often stored in databases (e.g., a Key, such as “Liquor Stores”) into something meaningful for the report (e.g., a Value, such as “State-operated stores which sell liquor but not beer. Closed early on Sundays.”)

Other examples include but aren't limited to the following.

Checkable List, which constitutes a list of text strings, each of which is rendered next to a checkbox. The End User may check one or more checkboxes. When the Analysis Report is generated, the text strings which were checked are included in the Prompt.

Radio List, which is a mutually exclusive version of a Checkable List where only one item may be selected at a time.

Question & Answer, which is a text-based question which the End User may answer in a text box. Both the Question and Answer are included in the Prompt.

Drop-down list, which is a mutually exclusive version of a Checkable List where only one item may be selected at a time, as represented in a Dropdown button.

In example embodiments, the NRS can comprise several novel mechanisms for manipulating and transforming text and other input data for the report. The mechanisms are described below in the order that they receive information, and each output is the input to the next mechanism, in a chain.

To begin, the End User would create a new Context in the Application Database, creating a new instance of the NRS. At this time the End User may select from multiple sources of Public Safety Data to determine which information is included in the report. The NRS may also include other relevant information from internal data sources, such as other Public Safety Data from the same jurisdiction.

In an example embodiment, the NRS has a mechanism for automatically proposing CII's for the following exemplary items, which the user may include or remove.
i. Jurisdiction-Detailed Description
ii. Topic Issue-Detailed Description
iii. Risk Narratives-One or more Question & Answer
iv. Included Stakeholders-Checkable List
v. Relevant Time-Detailed Description, including e.g. daytime, night-time, seasons, etc.

### Contextual Completeness Check

In an example embodiment, the NRS has a mechanism for determining Contextual Completeness, a state which is needed in order for the Report to be generated. Contextual Completeness is achieved when the Language Model (such as a Large Language Model, LLM) determines each CII is complete enough to provide additional context to the report being generated.

The determination is made through a fine-tuned Language Model which is trained to highlight and rate text on how ambiguous the relationship between the text and topic of the report is.

A mixture of fine-tuning and Prompt Engineering is used to achieve this. Fine-tuning increases the accuracy of the results and consistency of outputs while the model can be instructed to reason around a configurable, auto-generated request prompt such as: “On a scale of 1 to 5, with 1 being unrelated and 5 being the same topic, please rate the following information on how clearly it relates to our task of generating text content for a crime report about Robbery in New York City.\n \n \n [Insert CII].” This prompt is an example and may be configured by a user interface such as an NRS Admin Panel.

If any CII is rated as too ambiguous, the NRS asks for revisions from the End User to the CII for clarity. It achieves this by updating its Metadata which is interpreted by the Frontend and presented to the End User as a request for more information.

After each attempt, the ratings are stored in the NRS Metadata. Each subsequent attempt includes the previous attempt and the ratings from the attempt.

When all CII is deemed unambiguous, meaning all CII ambiguity ratings pass a configurable threshold (e.g., 4 or 5), the process may proceed. The End User may alternatively override this requirement via a setting in the Frontend.

The final output of this stage is used as a Starter Prompt for another Language Model, described in the next section below.

### Text Generation Technique

In an example embodiment, the NRS then has a mechanism for developing text content for the report through an iterative means of querying the Language Model and processing the output through a state machine described below. This mechanism requires a description of the final desired output, in prose form. This is described as the “Starter Prompt” for the text generation. The purpose of this novel technique is to develop content in a single user interaction that automates multiple phases of text-content generation and editing by the Language Model that otherwise would not be possible without manual additional querying of the LM.

In an example embodiment, the NRS utilized a fine-tuned Language Model to request an outline of the proposed content using the previously generated Starter Prompt with appended configurable, auto-generated instructions for the format of the outline. The NRS loops through each section of the generated outline and queries the LM for content for that section. The NRS then combines each section's content into a full text and queries the LM to edit and finalize the content.

In one example, an Output Prompt Template may be inserted. Such a template is written text that transforms the output in some manner, such as language translation. This process is iterative and recursive, in order to further develop content within subsections.

In practice, this disclosure describes using this mechanism like so: “The NRS uses the text generation technique to create content about Subject X.” This is interpreted as using the iterative process above with a Starter Prompt that could be summarized as “create content about Subject X.”

### Risk Narrative Development

In example embodiments, the NRS utilizes the method of generating text to develop content for each of the Risk Narratives included as CIIs, or if the End User has provided their Risk Narratives, to further develop their narratives. The NRS then marks itself for End User feedback in its Metadata to allow the End User to edit the Risk Narratives on the Frontend, if desired. Thereafter, the End User may confirm the Risk Narratives and begin report generation.

In example embodiments, the Language Model is provided with numerous examples of Risk Narratives and is prompted to generate new ideas for the selected Risk Narratives for this Report.

In example embodiments, the Risk Narratives are displayed and interacted with as Question & Answer CII's, where each Question is a location description of where the outcomes are occurring in this Report (e.g., “Assaults tend to happen within 1500 feet of bars”). Each Answer is a user-entered description of the Risk Narrative (i.e., an explanation of why that is occurring).

In an example embodiment, A Risk Narrative Prompt Template may be inserted. Such a template instructs the Language Model to reason about information from certain perspectives, such as from a Law Enforcement, Education, or Public Health perspective.

### Report Content Generation

In an example embodiment, the NRS uses the techniques described above to generate the content for a report.

The End User may use the Frontend to configure various settings. For example, the End User can choose from a selection of Risk Narrative Prompt Templates. These templates exist as written text created by administrators of the System. They consist of at least a title and a template body. The template body may be a template-ready text format, such as Embedded JavaScript (EJS), to allow for variable substitution in the prompt with Data. When selected, the written text is included in the Risk Narrative generation phase of report generation. In another example, the End User can choose from a selection of Output Prompt Templates. Similarly, these exist as written text and when selected are included in the editing and finalization step of the report during text generation. They consist of at least a title and a template body. The template body may be a template-ready text format, such as EJS, to allow for variable substitution in the prompt with Data.

In yet another example, the End User can choose from a selection of Output Formats, such as Microsoft Word Documents, PDFs, PowerPoint Presentations, etc. This is a brief prompt that describes the output format the LLM should follow. It consists of at least a title and a template body. The template body may be a template-ready text format, such as EJS, to allow for variable substitution in the prompt with Data.

In example embodiments, the NRS can use:
a text generation technique to interpret Data included in the Report;
a text generation technique to create content for Risk Narratives;
a text generation technique to generate content for the mid-section of the report that is consistent with the Risk Narrative and Output Prompt Template;
a text generation technique to generate content for a “Conclusion” section which summarizes the results and proposes next steps.

The NRS then prompts the Language Model to combine and edit the resulting text for clarity, resulting in the body text of the Report.

Each of the steps above can be followed with a configurable Starter Prompt managed by NRS Administrators.

### Preview Generation

In an example embodiment, the NRS uses a fine-tuned Language Model to translate the report content into a Markdown Preview using the selected Output Format. The LM is fine-tuned to generate Markdown that is context-aware of the Output Format, such as inserting page or slide delimiters and formatting for various presentation formats. The NRS marks itself for user feedback and the user is presented the content of the Preview.

### User Editing Feedback Loop

The Frontend translates the Preview content into a usable format in the Web Browser. For most text this means a translation into HyperText Markup Language (HTML). The Frontend is also content-aware and attempts to present the output in such a manner that digitally reflects its intended physical output when possible. For example, an Output Format of a PowerPoint Presentation is visually presented to the user one “slide” at a time by detecting the inserted delimiters from the LLM.

In an example embodiment, the Frontend allows the End User to highlight any range of text or paragraph and presents the End User with multiple options for text manipulation.

These options can be listed from available Information Transforms (“IT's”), which are technical processes or algorithms which implement certain functionalities that take text as input and output. The following exemplary Information Transforms can be available: Translate to another language, Think of a metaphor, Rewrite this for another education level, Rewrite this for another audience of another cultural background, and Summarize this. IT's can also be available for the document globally, and apply to the entire document when used.

### Branding Configuration

In an example embodiment, the Frontend allows the user to configure various style parameters which modify the digital outputs of the reports. These can include branding colors and logos or badge images, and other style information.

### Report Exports to Multiple Formats

In an example embodiment, the NRS allows the End User to export the Report to a downloadable format appropriate to its Output Format. The NRS can first use a combination of fine-tuned LLM and string search techniques to check for hallucinated numerical information or facts. If found, the NRS marks itself for user feedback and updates the Metadata to include a message for the user to revise the sections which are detected to be false. This step may be bypassed by user action to account for false positives.

Next, the NRS transforms the Markdown Preview into an appropriate digital format for the selected Output Format. Exemplary supported formats are:
HTML: The NRS uses an off-the-shelf Markdown to HTML converter;
Word Doc: The NRS implements a Markdown to Word Doc converter;
PPT: The Bar implements a Markdown to PPT converter using the delimiters from its fine-tuned LM's output to determine slide breaks;
PDF: The NRS generates HTML, then uses an HTML to PDF converter.

Each of these formats takes into account the End User style preferences saved with their account. Each format capable of multimedia content instructs its LLM during content generation to insert text placeholders in the Preview for graphics or map images. These text placeholders are translated into placeholder images that contain graphics representing what should be placed there by the End User after downloading.

New formats may be added without materially changing the overall architecture of the disclosure. The digital output is saved to the report storage location and the metadata is saved to the database. The End User is presented with a list of all the reports in order to see a history and iterate. Previously generated reports can be duplicated as a new starting point for another report. Each record in the list contains a download button which allows the End User to download the digital file to their local computer for distribution. Each record in the list contains a distribute to mobile button which allows the End User to make the report available via an Application Programming Interface endpoint.

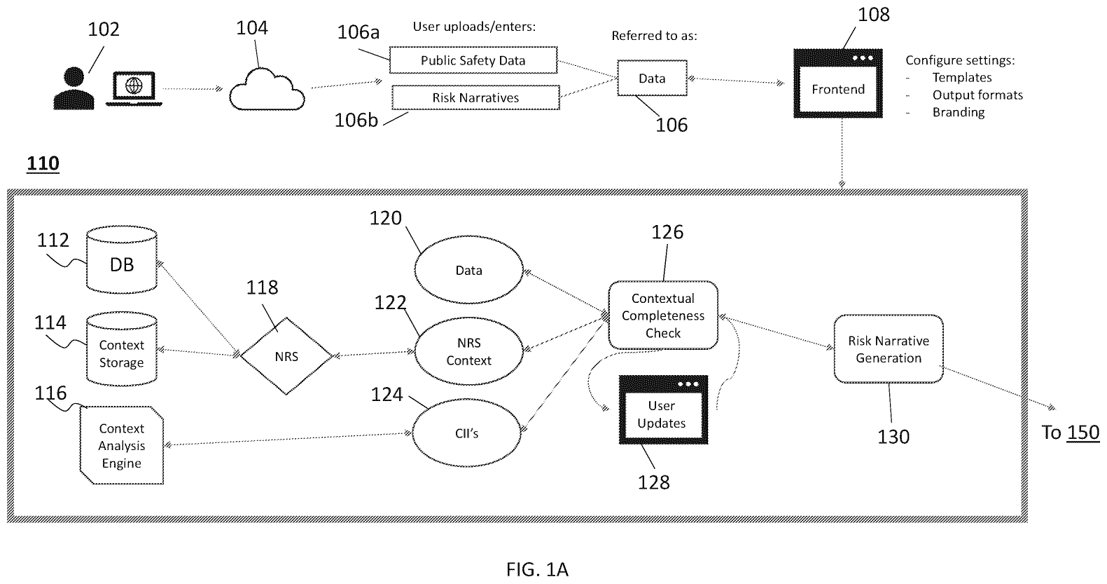

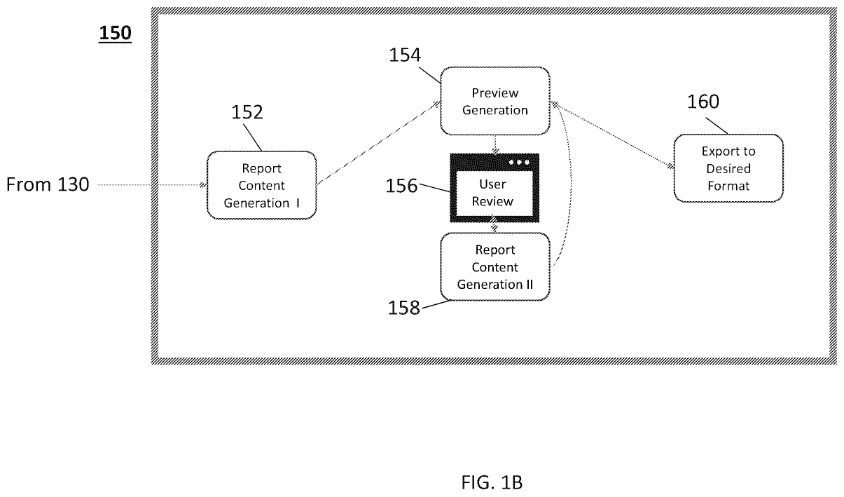

The operation of the disclosure described herein is illustrated by the example shown in FIGS. 1A, 1B, 2, and 3.

Referring to FIG. 1A, End User 102, optionally via internet 104, uploads data 106 (e.g., public safety data 106a and/or risk narratives 106b) into frontend 108. Frontend 108 connects to Context Analysis Engine 110. Context Analysis Engine 110 is an analytical tool used to break a problem down into smaller contextual relationships that can be addressed independently-most commonly this is Risk Terrain Modeling used on Crime Data but it can also be risk modeling on, for example, financial data for white collar crime prevention type activities.

Engine 110 comprises DB 112, context storage 114, context analysis engine 116, NRS module 118. Engine 110 employs data module 120, NRS context module 122, and CII module 124. The NRS context module 122 can load context using an NRS module that interfaces with a database 112 and context storage 114. The CII module 124 can load information from a context analysis engine 116. Engine 110 performs contextual completeness check (e.g., using contextual completeness check module 126) based, in part, on user updates 128 and data 120, NRS context 122, and CII 124. After a successful contextual completeness check, engine 110 performs Risk Narrative Generation (Risk Narrative Generation module 130), the output of which is transmitted to Report Engine 150.

Exemplary connectivity of operations and modules of engine 110 is shown in FIG. 1A.

Referring to FIG. 1B, Report Engine 150 comprises Report Content Generation module 152, Preview Generation module I 154, User Review module 156, Report Generation module II 158, and Export module 160.

Exemplary connectivity of operations and modules of engine 150 is shown in FIG. 1B. For example, the report content generation I module 152 can receive a risk narrative generation report from the risk narrative generation module 130. The resulting outputted report can be sent to the preview generation module 154. The user review module 156 presents the preview to the user, where a second report generation module 158 can receive updates (e.g., from the user interface via user review). The updated report can be exported 160 to a desired format.

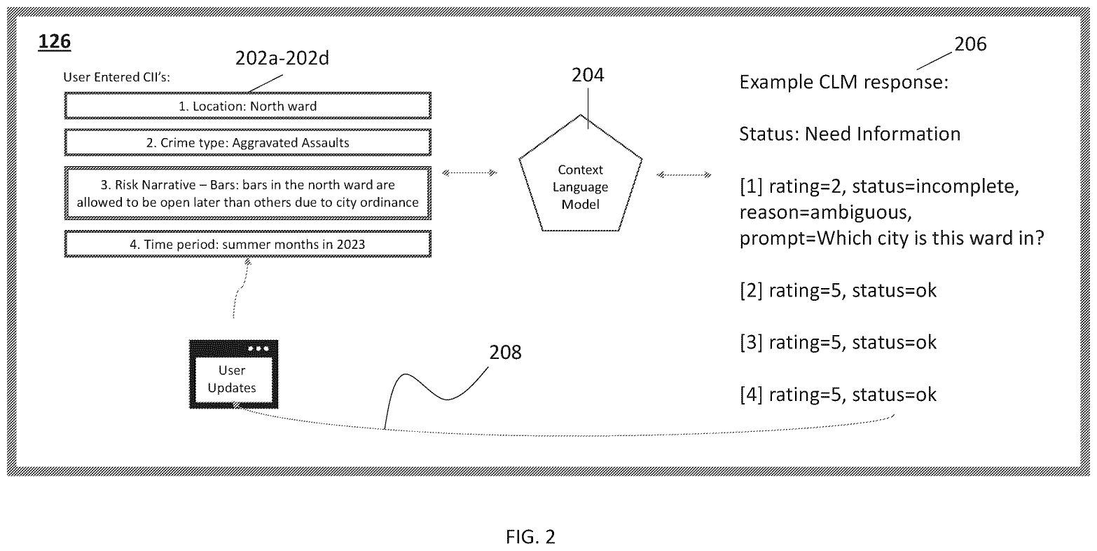

The exemplary operational details of Contextual Completeness Check module 126 are shown in FIG. 2. Based on user updates 202a through 202d, Context Language Model (CLM) 204 generates CLM Response 206. Examples of the user updates (e.g., user entered CIIs) include a location, a crime type, a risk narrative, and a time period. This process can be iterative, as indicated by arrow 208: the CIIs can be repeatedly edited, new assessments can be requested, and the end user can respond to new prompts, such as what information would be needed to help complete the report, like a location of the incident.

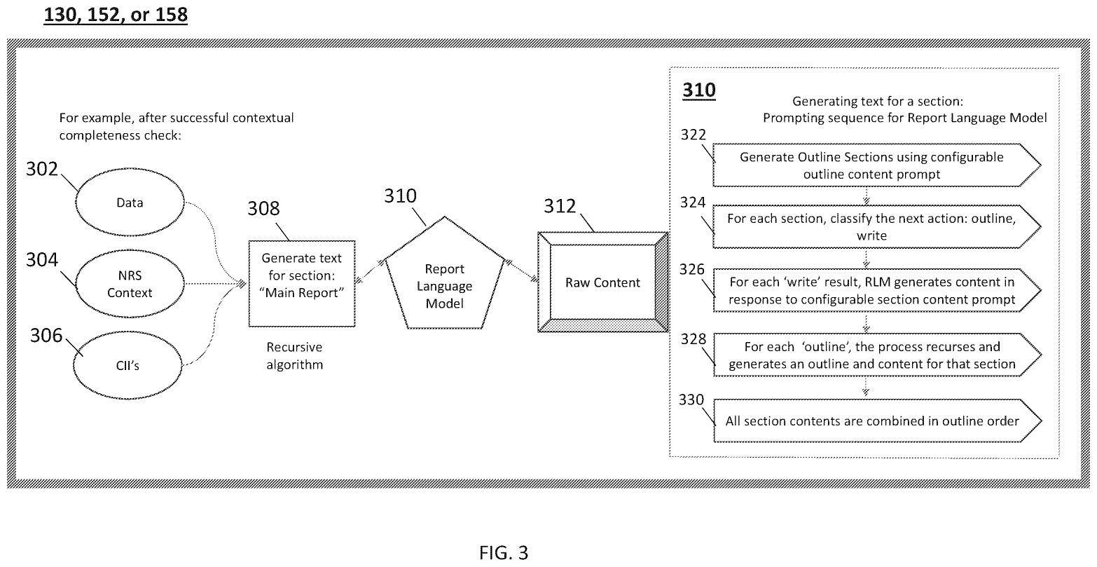

As mentioned above with respect to FIG. 1A and FIG. 1B, after a successful contextual completeness check, engine 110 performs Risk Narrative Generation 130, the output of which is transmitted to Report Engine 150. The exemplary operational details of Risk Narrative Generation module 130, Report Content Generation module I 152, and Report Content Generation module II 158 are similar and are illustrated in FIG. 3.

In the example shown in FIG. 3, based on data 302, NRS Context 304, CII's 306, and raw content 312, Report Language Model 310 generates section text 308. Exemplary steps performed by Report Language Model 310 are shown in the inset as steps 322, 324, 326, 328, and 330.

For example, to generate text for a section, a method can generate outline sections using configurable outline content prompts (322). The method can, for each section, classify the next action (e.g., outline, write, etc.) (324). The method can, for each result of a writing action, generate content using an RLM in response to the configurable section content prompt (326). The method can, for each outline action, recursively run the method 310 on that outline section to generate an outline and content for that section (328). The method can combine all section contents in outline order (330).

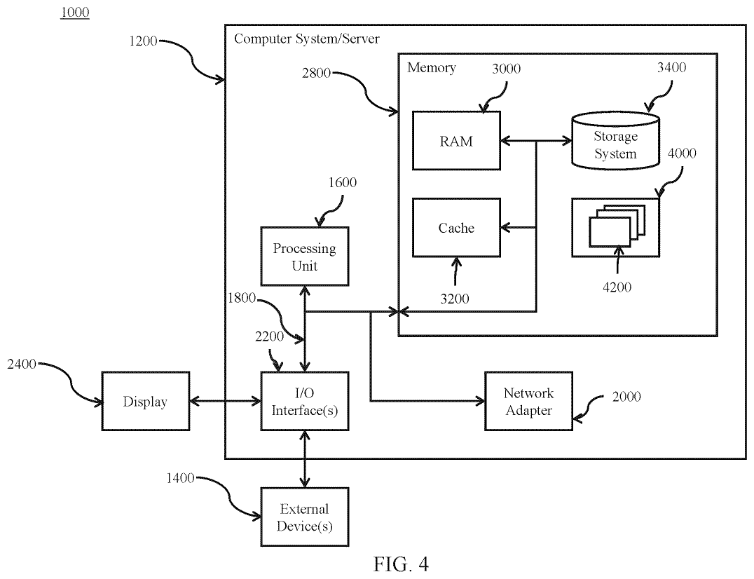

In various embodiments, the system described herein, including any of the modules described above, can comprise at least one computer node 1000 as shown in FIG. 4.

As shown in FIG. 4, computer system/server 1200 in computing node 1000 is shown in the form of a general-purpose computing device. The components of computer system/server 1200 may include, but are not limited to, one or more processors or processing units 1600, a system memory 2800, and a bus 1800 that couples various system components including system memory to processor 1600.

Bus 1800 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 1200 typically includes a variety of computer system readable media. Such media may be any available media that is accessible by computer system/server 1200, and it includes both volatile and non-volatile media, removable and non-removable media.

System memory 2800 can include computer system readable media in the form of volatile memory, such as random access memory (RAM) 3000 and/or cache memory 3200. Computer system/server 1200 may further include other removable/non-removable, volatile/non-volatile computer system storage media. By way of example only, storage system 3400 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1800 by one or more data media interfaces. As will be further depicted and described below, memory 2800 may include at least one program product having a set (e.g., at least one) of program modules that are configured to carry out the functions of embodiments of the disclosure.

Program/utility 4000, having a set (at least one) of program modules 4200, may be stored in memory 2800 by way of example, and not limitation, as well as an operating system, one or more application programs, other program modules, and program data. Each of the operating system, one or more application programs, other program modules, and program data or some combination thereof, may include an implementation of a networking environment. Program modules 4200 generally carry out the functions and/or methodologies of embodiments as described herein.

Computer system/server 1200 may also communicate with one or more external devices 140 such as a keyboard, a pointing device, a display 2400, etc.; one or more devices that enable a user to interact with computer system/server 1200; and/or any devices (e.g., network card, modem, etc.) that enable computer system/server 1200 to communicate with one or more other computing devices. Such communication can occur via Input/Output (I/O) interfaces 2200. Still yet, computer system/server 1200 can communicate with one or more networks such as a local area network (LAN), a general wide area network (WAN), and/or a public network (e.g., the Internet) via network adapter 2000. As depicted, network adapter 2000 communicates with the other components of computer system/server 1200 via bus 1800. It should be understood that although not shown, other hardware and/or software components could be used in conjunction with computer system/server 1200. Examples, include, but are not limited to: microcode, device drivers, redundant processing units, external disk drive arrays, RAID systems, tape drives, and data archival storage systems, etc.

Accordingly, in a first example embodiment, the present disclosure is a method of textual report generation. In a 1^{st} aspect of the 1^{st} example embodiment, the method comprises: receiving a proposed report description and a report intent; providing the proposed report description and the report intent to a first large language model; prompting the first large language model to output a quality rating of the proposed report description with respect to the report intent; prompting the user to revise the proposed report description until the quality rating exceeds a predetermined threshold; providing the proposed report description and the report intent to a second large language model; and prompting the second large language model to generate a report according to the proposed report description and the report intent.

In a 2^{nd} aspect of the 1^{st} example embodiment, the method further comprises providing a user interface to a user; and receiving from the user via the user interface the proposed report description and the report intent. The remainder of features and example features are as described above with respect to the 1^{st} aspect of the 1^{st} example embodiment.

In a 3^{rd} aspect of the 1^{st} example embodiment, the method further comprises outputting the report to the user. The remainder of features and example features are as described above with respect to the 1^{st} and 2^{nd} aspect of the 1^{st} example embodiment.

In a 4th aspect of the 1^{st} example embodiment, the quality rating corresponds to ambiguity. The remainder of features and example features are as described above with respect to the 1^{st} through 3^{rd} aspects of the 1^{st} example embodiment.

In a 5th aspect of the 1^{st} example embodiment, the method further comprises, based on the proposed report description and/or report intent, retrieving contextual data corresponding thereto; and providing the contextual information to the second large language model with the proposed report description and the report intent. The remainder of features and example features are as described above with respect to the 1^{st} through 4th aspects of the 1^{st} example embodiment.

In a second example embodiment, the present disclosure is a computer program product for textual report generation, the computer program product comprising a computer readable storage medium having program instructions embodied therewith. In a 1^{st} aspect of the 2^{nd} example embodiment, the program instructions executable by a processor cause the processor to perform a method according to the 1^{st} example embodiment and any aspects thereof.

The teachings of all patents, published applications and references cited herein are incorporated by reference in their entirety.

While this disclosure has been particularly shown and described with references to example embodiments thereof, it will be understood by those skilled in the art that various changes in form and details may be made therein without departing from the scope of the disclosure encompassed by the appended claims.

What is claimed is:

1. A method of textual report generation, comprising:
receiving a proposed report description and a report intent;
providing the proposed report description and the report intent to a first large language model;
prompting the first large language model to output a quality rating of the proposed report description with respect to the report intent;
prompting a user to revise the proposed report description until the quality rating exceeds a predetermined threshold;
providing the proposed report description and the report intent to a second large language model; and
prompting the second large language model to generate a report according to the proposed report description and the report intent.

2. The method of claim 1, further comprising:
providing a user interface to a user; and
receiving from the user via the user interface the proposed report description and the report intent.

3. The method of claim 2, further comprising:
outputting the report to the user.

4. The method of claim 1, wherein the quality rating corresponds to ambiguity.

5. The method of claim 1, further comprising:
based on the proposed one or more of the report description and report intent, retrieving contextual data corresponding thereto;
providing the contextual data to the second large language model with the proposed report description and the report intent.

6. A computer program product for textual report generation, the computer program product comprising a computer readable storage medium having program instructions embodied therewith, the program instructions executable by a processor to cause the processor to perform a method, the method comprising:
receiving a proposed report description and a report intent;
providing the proposed report description and the report intent to a first large language model;
prompting the first large language model to output a quality rating of the proposed report description with respect to the report intent;
prompting a user to revise the proposed report description until the quality rating exceeds a predetermined threshold;
providing the proposed report description and the report intent to a second large language model; and
prompting the second large language model to generate a report according to the proposed report description and the report intent.

7. The computer program product of claim 6, wherein the method executed by the processor further comprises:
providing a user interface to a user; and
receiving from the user via the user interface the proposed report description and the report intent.

8. The computer program product of claim 7, wherein the method executed by the processor further comprises:
outputting the report to the user.

9. The computer program product of claim 6, wherein the quality rating corresponds to ambiguity.

10. The computer program product of claim 6, wherein the method executed by the processor further comprises:
based on the proposed one or more of the report description and report intent, retrieving contextual data corresponding thereto; and
providing the contextual data to the second large language model with the proposed report description and the report intent.

11. A system comprising:
a computing node comprising a computer readable storage medium having program instructions embodied therewith, the program instructions executable by a processor of the computing node to cause the processor to perform a method comprising:
receiving a proposed report description and a report intent;
providing the proposed report description and the report intent to a first large language model;
prompting the first large language model to output a quality rating of the proposed report description with respect to the report intent;
prompting a user to revise the proposed report description until the quality rating exceeds a predetermined threshold;
providing the proposed report description and the report intent to a second large language model; and
prompting the second large language model to generate a report according to the proposed report description and the report intent.

12. The system of claim 11, wherein the method executed by the processor further comprises:
providing a user interface to a user; and
receiving from the user via the user interface the proposed report description and the report intent.

13. The system of claim 12, wherein the method executed by the processor further comprises:
outputting the report to the user.

14. The system of claim 11, wherein the quality rating corresponds to ambiguity.

15. The system of claim 11, wherein the method executed by the processor further comprises:
based on the proposed one or more of the report description and report intent, retrieving contextual data corresponding thereto; and
providing the contextual data to the second large language model with the proposed report description and the report intent.
